(19) United States
(12) Patent Application Publication
(10) Pub. No.: US 2014/0287398 A1
(43) Pub. Date: Sep. 25, 2014

(54) Computer Implemented System and Method for Statistically Assessing Co-Scholastic Skills of a User

(71) Applicant: Gautam Singh, Mumbai (IN)

(72) Inventor: Gautam Singh, Mumbai (IN)

(21) Appl. No.: 14/296,852

(22) Filed: Jun. 5, 2014

Related U.S. Application Data
(63) Continuation of application No. PCT/IN2012/000766, filed on Nov. 23, 2012.

(30) Foreign Application Priority Data
Dec. 5, 2011 (IN) 3420/MUM/2011

(51) Int. Cl. G09B 7/06

(52) U.S. Cl. CPC G09B 7/06
USPC 434/350

(57) ABSTRACT

A system and method for assessing the co-scholastic skills of users have been disclosed. The system envisaged by the present disclosure envisages screening speechless short films to individuals in order to assess their strengths and weaknesses in co scholastic areas such as attitude towards life, moral values, critical thinking skills, creative thinking skills, decision making skills, analytical skills; problem solving skills, communication skills and emotional sensitivity. The system exploits various ideas, concepts and messages imparted by the short speechless movies to enhance the co-scholastic skills of individuals. The user is required to view the short speechless film displayed on a user interface. Subsequent to viewing the short speechless film, the user is required to answer an assessment test, preferably online assessment test. Based on the answers of users to the displayed assessment questions, the user's competency in co-scholastic skills is determined by an assessment processor.

### FIELD OF DISCLOSURE

The present disclosure relates to the field of online assessment tools. Particularly, the present disclosure relates to a computer implemented system for assessing co-scholastic skills of a user.

### BACKGROUND

An organization typically comprises people having diversified background. For example, a school comprises students from diversified cultural and socio-economic backgrounds. The cultural and socio economic background of a user has a bearing on the performance (academic/co scholastic) of the user.

Considering the case of a student attending a learning institution as an example, it can be said that the learning abilities of a student are reflected by student's co-scholastic abilities. Educational institutions emphasize on having a congenial student-teacher relationship so that the teacher is able to impart educational skills to the students in an effective manner. Educational institutions typically formulate several student clubs which act as an avenue for students to pursue their hobbies and interests and at the same time have a healthy interaction with the teachers.

The student clubs enable a student to associate with a teacher in an effective manner and have a good relationship with the teacher which in turn has a bearing on the rate of knowledge transfer. Not only for students, but for all the individuals, it is necessary to have a healthy working relationship with other individuals in a working atmosphere so that there is a healthy interaction, growth and knowledge transfer.

Co scholastic areas such as life skills, attitude towards life, moral values are of importance since they enable an individual to have a better personality. The evaluation of an individual with co-scholastic skills in perspective provide for the measurement of the individual's strengths and weaknesses, which can be worked upon by the individual with or without assistance, at a later date. In case of students, the performance of a student in a co-scholastic area enables a teacher to understand the specific academic, psychological and emotional needs of the student. Understanding of emotional and psychological needs of an individual helps for facilitation of the same thereby providing for development of overall personality of the individual.

When it comes to imparting education to students, many of the educational institutions are still following the conventional methods of educating students. One of the drawbacks of the conventional educational systems is that it recognizes the academic performance of a student based solely on academic grades/scores. The conventional system provides lesser emphasis on the co-scholastic skills of the student.

Of late, multimedia presentations have been used as a mode for imparting co-scholastic skills to users, especially students. Multimedia presentations including movies, music, animated presentations and digital photographs have been extensively used in the conventional educational system to enhance the co-scholastic abilities of users. However, none of the conventional systems make use of speechless short films to enhance the co-scholastic skills of users.

Several attempts have been previously made to overcome the drawbacks associated with the conventional education system. For example, United States Patent Application 20070172810 discloses a method and system for providing educational assessment of reading performance for a student. In accordance with this patent application, after the user (student) logs-in, he/she is provided with a multimedia presentation including sound, image, animation, video and text. The student's comprehension is tested based on the displayed multimedia content. The system includes a diagnostic engine that presents additional questions on the displayed multimedia presentation, based on the previous performances of the student. The focus of the system envisaged by this patent application is restricted to testing the reading comprehension of a student.

U.S. Pat. No. 5,267,865 discloses an educational method and a system for executing an educational method. The patent teaches monitoring the student's progress and pacing the course material to the student's ability to learn and comprehend. The system envisaged by this patent includes a plurality of student workstations connected to a teacher's workstation via a LAN interface, thereby enabling real time communication between students' terminal and the teacher's terminal. Such a communication also allows the teacher to be informed about the progress and activities of the students thereby enabling teachers to accordingly tailor instructional programs for each student. In accordance with this patent application, the courseware to be taught can be prepared uniquely for each class or for each school. The term ‘courseware’ in accordance with this patent includes information stored on a hard drive and meant to be displayed to a student. The courseware includes a plurality of lesson segments that are to be viewed by the students. The patent clearly states that the lesson segments comprise an oral illustration of the information contained in the lesson segment. This patent discloses a teaching method that is strictly based on the academic curriculum and does not emphasize on development of co-scholastic skills of students.

United States Patent Application 20080241804 discloses a brain jogging system. In accordance with this patent application, a series of visual stimuli are provided to the user. The user is required to process the stimuli and produce a verbalization that corresponds to the visual stimuli. The visual stimuli in accordance with this patent application include letters, words and phrases. In accordance with this patent application, the user, after viewing visual stimuli is required to reproduce, i.e., input the displayed letters, words and phrases via an input device such as a keyboard. The system in accordance with this patent application also produces letter flash activities, word flash activities to test a user's mental ability. The focus of the system envisaged by this patent application is on displaying visual stimuli that are in the form of letters, words and phrases for conducting eye movement activities, letter flash activities and word flash activities. In accordance with this patent application, eye movement activities involve displaying a set of words on a seen and subsequently varying the position of the word on the screen, and asking the user to recite the first word and last word from the set of words displayed at first. In accordance with this patent application, letter flash activity involves displaying a set of words for a predetermined amount of time and asking the user to retype the words thereafter. In accordance with this patent application, word flash activity involves displaying a list of words for a predetermined amount of time and asking the user to retype the word list thereafter. This patent application focuses on displaying only letters, words and phrases and provides a basic mode of learning to the user, rather on concentrating on the development of co-scholastic activities of individuals.

U.S. Pat. No. 5,267,865 discloses a method for testing users for alertness and mental fitness before they embark on a particular activity. In accordance with this patent, users are provided with a plurality of ‘yes’ or ‘no’ type of questions which are based on the displayed graphical data. In accordance with this patent, a check board pattern is displayed to the user on a display module. A plurality of black squares are displayed as the background while various figures such as circles, rectangles and arrows are displayed in remaining white squares in different orientations. The user's task is to press ‘yes’ when all the shapes are the same and otherwise press ‘no’. The focus of the system envisaged by this patent is on displaying a check board having a combination of black colored and white colored spaces, and displaying a plurality of shapes including squares, circles, and arrows in white colored spaces and prompting the user to appropriately identify the displayed patterns (squares, circles and arrows). This patent also focuses providing a basic mode of learning to the user, rather on concentrating on the development of co-scholastic activities of individuals.

Great Britain Patent Application 2450692 teaches a method for tutoring individual elements of a multi element task. The system, in accordance with this patent includes data files comprising information about how to perform an element of a multi element task. The system includes a means for manipulating the information stored in the data files. This patent concentrates on providing music tracks as video files which could be utilized by music learners to learn music. This patent emphasizes on playing video files of individual learning tasks contrary to the present disclosure which teaches playing muted video illustrations to students. This patent also focuses providing a basic mode of learning to the user, rather on concentrating on the development of co-scholastic activities of individuals.

Since none of the systems of the prior art concentrated upon providing a system that helped in assessment of co-scholastic skills of users and only focused towards providing learning models that concentrated heavily upon the academic curriculum, there was felt a need for a system that provided for assessment of co-scholastic skills of users.

Further, there was felt a need for a system which provided users with an opportunity for expressing themselves. There was also felt a need for a system which facilitated continuous and comprehensive assessment of co-scholastic skills of users.

### Objects

Some of the objects of the present disclosure are described herein below:

It is an object of the present disclosure to ameliorate one or more problems of the prior art or to at least provide a useful alternative.

An object of the present disclosure is to provide a system that provides statistical measurements of users' competency and performance in co-scholastic areas.

Another object of the present disclosure is to provide a system that accurately accesses the user's strengths and weaknesses.

Yet another object of the present disclosure is to provide a system that provides quantifiable feedback to the user regarding his/her performance in co-scholastic activities.

Still a further object of the present disclosure is to provide a system that accurately tracks the overall performance of users in exhibiting co-scholastic skills.

One more object of the present disclosure is to provide a system that eliminates the requirement of manual feedback process.

Another object of the present disclosure is to provide a system that automates the process of assessing users' competencies in co scholastic skills.

Still a further object of the present disclosure is to provide a system that generates statistical reports denoting the level of co scholastic skills present in the user.

Another object of the present disclosure is to provide a system that enables users to develop their personalities by providing them with a means for expressing themselves.

Still a further object of the present disclosure is to provide a system that helps for continuous monitoring and assessment of co scholastic skills of users.

Yet another object of the present disclosure is to provide a system that enables users to enhance their problem solving skills.

Still a further object of the present disclosure is to provide a system that enables users to become independent learners.

Other objects and advantages of the present invention will be more apparent from the following description when read in conjunction with the accompanying figures, which are not intended to limit the scope of the present invention.

### SUMMARY

The present disclosure envisages a computer implemented system for statistically assessing co-scholastic skills of a user. The system, in accordance with the present disclosure comprises:
a menu generator configured to generate a menu accessible to said user, said menu having a plurality of menu options configured to extract information corresponding to at least user's age, user's sensibility levels and user's cultural milieu;
a first repository configured to store a plurality of speechless short films, the first repository further configured to store information corresponding to at least user's age, sensibility levels and cultural milieu;
a first annotator cooperating with the repository, the first annotator configured to annotate the speechless short films based on at least user's age, sensibility levels and cultural milieu;
a selection module configured to automatically select at least one speechless short film to be displayed to the user, based on at least the user's age, sensibility levels and cultural milieu;
a first user interface configured to display the speechless short film to the user;
an assessment processor configured to generate an assessment test for evaluating the scholastic skills of the user, wherein the assessment test includes at least one set of assessment questions based on the short speechless film displayed to the user, the assessment processor comprising:
   a second repository configured to store a plurality of sets of assessment questions, wherein each set of assessment questions correspond to a short speechless film stored in the first repository;
   a second annotator configured to annotate the plurality of sets of assessment questions based on at least the short speechless film that the assessment questions correspond to, language of assessment questions, user's age, user's sensibility levels and user's cultural milieu;
   an extractor configured to extract at least one set of assessment questions from the second repository based on the speechless short film displayed to the user and based on the menu options selected by the user;
   a preparatory module configured to prepare an assessment questionnaire comprising the assessment questions extracted by the extractor;
   a second user interface configured to display the assessment questionnaire to the user, the second user further configured to enable the user to answer each question of the assessment questionnaire; and
   an evaluator configured to evaluate the answers provided by the student for correctness, the evaluator configured to evaluate the performance of the user with relation to a plurality of co-scholastic skills, based on the answers provided by the user.

In accordance with the present disclosure, the first user interface is further configured to display information corresponding to the short speechless films previously viewed by the user and assessment tests previously answered by the user.

In accordance with the present disclosure, the first user interface is configured to display information corresponding to the short speechless film(s) to be displayed to the user and the pattern of the corresponding assessment questionnaire.

In accordance with the present disclosure, the selection module is further configured to select a short speechless movie based on academic curriculum prescribed to the user.

In accordance with the present disclosure, the plurality of sets of assessment questions stored in the second repository include multiple choice assessment questions

In accordance with the present disclosure, the second repository is further configured to store the answers to the plurality of sets of assessment questions.

In accordance with the present disclosure, the evaluator is further configured to generate statistical graphs indicating the performance of the user in the assessment test.

In accordance with the present disclosure, the system further includes a scoring module configured to assign scores to the user according to the user's performance in the assessment test.

In accordance with the present disclosure, the system further includes a report generation module configured to generate customized report(s) illustrating the performance of the user in the assessment test.

In accordance with the present disclosure, the evaluator is configured to evaluate the performance of the user with relation to a plurality of co-scholastic skills including at least critical thinking skills, creative thinking skills, decision making skills, problem solving skills, effective communication skills, interpersonal relationship skills, emotional sensitivity and stress handling skills.

The present disclosure envisages a computer implemented method for statistically assessing co-scholastic skills of a user. The method, in accordance with the present disclosure includes the following computer implemented steps:
generating a menu accessible to the user, said menu having a plurality of menu options configured to extract information corresponding to at least user's age, user's sensibility levels and user's cultural milieu;
storing a plurality of speechless short films and the information corresponding to at least user's age, sensibility levels and cultural milieu, in a first repository.
annotating the speechless short films based on at least the user's age, sensibility levels and cultural milieu;
automatically selecting at least one speechless short film to be displayed to the user, wherein the selection is based upon at least the user's age, sensibility levels and cultural milieu;
displaying selected short speechless movie to the user;
storing in a second repository a plurality of sets of assessment questions wherein each set of assessment questions correspond to a short speechless film stored in the first repository;
annotating the plurality of sets of assessment questions based on at least the short speechless film that the assessment questions correspond to, language of assessment questions, user's age, user's sensibility levels and user's cultural milieu;
generating a menu accessible to the user, wherein the menu comprises a plurality of menu options including at least the language of assessment questions, user's age, user's sensibility levels and user's cultural milieu;
extracting at least one set of assessment questions from the second repository based on the speechless short film displayed to the user and based on the menu options selected by the user;
preparing an assessment questionnaire comprising the extracted assessment questions;
displaying the assessment questionnaire on a second user interface to the user and enabling the user to answer each assessment question of the assessment questionnaire; and
evaluating the answers provided by the student for correctness, and evaluating the performance of the user with relation to a plurality of co-scholastic skills, based on the answers provided by the user.

In accordance with the present disclosure, the step of displaying a speechless short film to the user further includes the following steps:
displaying information corresponding to the short speechless films previously viewed by the user;
displaying information corresponding to the assessment tests previously answered by the user;
displaying information corresponding to the short speechless films to be displayed to the user and the pattern of the corresponding assessment questionnaire.

In accordance with the present disclosure, the step of automatically selecting at least one speechless short film to be displayed to the user further includes the step of selecting at least one short film based on the academic curriculum prescribed to the user.

In accordance with the present disclosure, the step of storing in a second repository a plurality of sets of assessment questions further includes the step of storing multiple choice questions.

In accordance with the present disclosure, the method further includes the step of assigning scores to the user according to user's performance in the assessment test.

In accordance with the present disclosure, the method includes the step of generating statistical graphs and customized report(s) illustrating the performance of the user in the assessment test.

In accordance with the present disclosure, the step of evaluating the performance of the user with relation to a plurality of co-scholastic skills includes the step of evaluating the user based on at least critical thinking skills, creative thinking skills, decision making skills, problem solving skills, effective communication skills, interpersonal relationship skills, emotional sensitivity and stress handling skills.

### BRIEF DESCRIPTION OF ACCOMPANYING DRAWINGS

The system and method for statistically assessing co-scholastic skills of a user will now be described with reference to the accompanying, non-limiting drawings, in which:

FIG. 1 illustrates a schematic of a system for assessing the co-scholastic skills of a user; and

FIG. 2 and FIG. 3 illustrate a flowchart for a method of assessing the co-scholastic skills of a user.

### DETAILED DESCRIPTION OF ACCOMPANYING DRAWINGS

The system of the present disclosure will now be described with reference to the embodiments shown in the accompanying drawings. The embodiments do not limit the scope and ambit of the disclosure. The description relates purely to the examples and preferred embodiments of the disclosed method and its suggested applications.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The system and method for assessing co-scholastic skills of a user will now be described with reference to the accompanying drawings which do not restrict the scope and ambit of the disclosure. The description provided is purely by way of example and illustration.

The system envisaged by the present disclosure envisages screening high quality, speechless short films to individuals in order to assess their strengths and weaknesses in co scholastic areas such as life skills, attitude towards life, thinking skills, emotional skills and social skills.

The system exploits various ideas, concepts and messages imparted by the short speechless movies to enhance the co-scholastic skills of individuals.

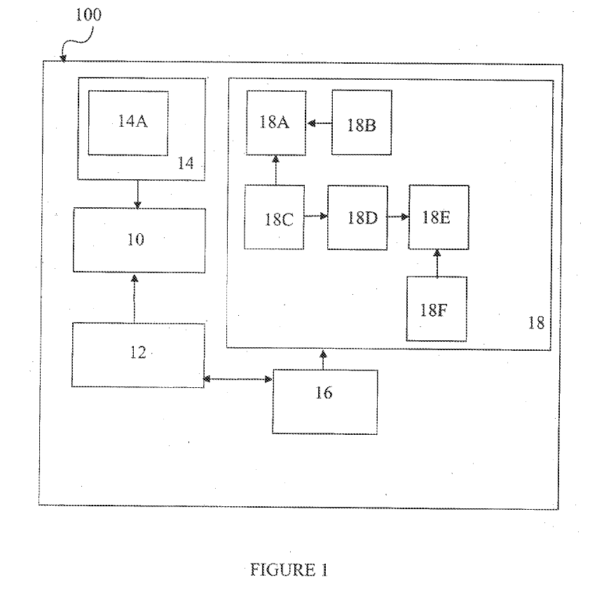

The computer implemented system for assessing co-scholastic skills of a user will now be described with reference to FIG. 1, wherein reference numeral 100 denotes the system for assessing co-scholastic skills of a user. The system 100 includes a first repository 10 that is configured to store a plurality of speechless short films. The speechless short films stored in the first repository 10 include video presentations concentrating on a plurality of co-scholastic skills including critical thinking skills, creative thinking skills, social skills, decision making skills, problem solving skills, effective communication skills, interpersonal relationship skills, emotional sensitivity and the like. The speechless short movies, as the name suggests are short films running up to for example ‘20’ minutes and do not contain spoken languages. These short speechless movies might optionally include sounds for special effects and background score but do not contain any verbal conversations between the characters depicted in the film.

The first repository 10, in accordance with the present disclosure also stores at least information corresponding to users' age, sensibility levels (preferably rated by the user himself on a scale of 1-10) and cultural milieu (provided by the user himself). The user provides the information corresponding to the age, sensibility level and cultural milieu (cultural background) through a first user interface 14 communicably coupled to the first repository 10. The first user interface 14 includes a menu generator 14A which is configured to generate a menu comprising a plurality of menu options configured to elicit information from the user including user's age, sensibility levels and cultural milieu.

The system 100, in accordance with the present disclosure includes a first annotator 12 cooperating with the first repository 10 and configured to annotate the short speechless films as per user's age, sensibility levels and cultural milieu. The first annotator 12 annotates the short speechless films as suitable to the user of a certain age, sensibility level and cultural milieu and further classifies the short speechless films according to the age group, cultural milieu and sensibility levels of users. For example, for a user ‘A’ aged ‘10’ having sensibility level ‘5’ and cultural milieu as being ‘Indian’, a short speechless movie titled ‘FF’ might be appropriate, and for a user aged ‘20’, having sensibility level ‘7’ and cultural milieu as being ‘French’, a short speechless movie ‘EE’ could be appropriate. The first annotator 12 annotates and classifies the short speechless movies as per the aforementioned example. The short speechless films annotated by the first annotator 12 according to at least the users' age, cultural milieu and sensibility levels are stored in the first repository 10.

In accordance with the present disclosure, the first user interface 14 enables a user to access the system 100. When a user logs on to the system 100, a menu bar is displayed on the user interface showing two sections, namely ‘history’ and ‘current assignment’. The section ‘history’ stores the information corresponding to all the short speechless movies previously viewed by the user and the section ‘current assignment’ stores the information corresponding to the current short speechless movie to be viewed by the user.

In accordance with the present disclosure, when a user logs on to the system 100 to view a short speechless movie, he is required to provide his age, cultural milieu and sensibility levels. The information provided by the user is stored in the first repository 12. The short films stored in the first repository 12 are annotated and classified by the first annotator 12 based on user's age, sensibility levels and cultural milieu. The system 100 further includes a selection module 16 configured to select a short speechless movie to be screened to the user based on user's age, sensibility levels and cultural milieu. The selection module 16 selects tit least one short speechless film from the first repository 12 based on the values provided by the user corresponding to his age, sensibility level and cultural milieu.

The short speechless film selected by the selection module 16 is screened/displayed to the user on the first user interface 14. The user is required to view the short speechless film displayed on the user interface 14. Subsequent to viewing the short speechless film, the user is required to answer an assessment test, preferably online assessment test.

The system 100, in accordance with the present disclosure includes an assessment processor denoted by the reference numeral 18. The assessment processor 18 is configured to generate an assessment test based on the short speechless film screened to the user. The assessment questions contained in the assessment questionnaire are based on the short speechless movie displayed to the user on the user interface 14.

In accordance with the present disclosure, the assessment processor 18 comprises a second repository 18A configured to store a plurality of sets of assessment questions wherein each set of assessment questions correspond to a particular short speechless movie. Each of the assessment questions in the assessment questionnaire relate to co-scholastic skills including but not restricted to attitude towards life, moral values, critical thinking skills, creative thinking skills, decision making skills, analytical skills, problem solving skills, communication skills and emotional sensitivity. Based on the answers of users to the displayed assessment questions, the user's competency in co-scholastic skills is determined by the assessment processor 18. The second repository 18A also stores the correct answers to each of the assessment question set.

The assessment processor 18 further comprises a second annotator 18B configured to annotate and classify the sets of assessment questions stored in the second repository 18A, based on the short speechless movie that they correspond to, user's age, user's sensibility levels and user's cultural milieu. The second annotator 18B obtains the information about user's age, sensibility levels and cultural milieu from the first repository 10. The short speechless films stored in the first repository and the sets of assessment questions stored in the second repository always have a one-to-one mapping. Therefore, by using the aforementioned information, the second annotator classifies and annotates the sets of assessment questions. For example, a user having watched a short speechless movie ‘A’, aged ‘12’, having cultural milieu of being ‘Indian’ and having sensibility level of ‘8’, would have to answer an assessment question set ‘A’. Similarly, another user having watched a short speechless movie ‘B’, aged ‘17’, having cultural milieu of being ‘Indian’ and having sensibility level of ‘6’, would have to answer an assessment question set ‘B’. In this manner the sets of assessment questions are annotated and classified by the second annotator 18B.

The system 100 further includes an extractor 18C configured to extract at least one set of assessment questions from the second repository 18A. Such an extraction is based on the short speechless film displayed to the user and the menu options inputted/selected by the user, i.e., user's age, user's sensibility levels and user's cultural milieu. The system, in accordance with the present disclosure includes a preparatory module 18D configured to prepare an assessment questionnaire comprising the assessment questions extracted by the extractor 18C.

The assessment questions, in accordance with the present disclosure are typically multiple choice questions, i.e., each question has a plurality of options as answers. The assessment questionnaire comprising multiple choice assessment questions are displayed to the user on a second user interface 18E. The second user interface 18E enables the user to answer each of the assessment questions by selecting the appropriate option as the answer. The user can select the appropriate answer either by touch, if the second user interface is being displayed on a touch screen or by a click if the second user interface is being displayed on a conventional display screen.

The system 100 further includes an evaluator 18F configured to evaluate the answers provided by the user for correctness. The evaluator cooperates with the second repository 18A which stores the correct answers to each of the sets of assessment questions, to evaluate the answers provided by the user. The assessment questions contained in the assessment questionnaire relate to various co-scholastic skills including but not restricted to attitude towards life, moral values, critical thinking skills, creative thinking skills, decision making skills, analytical skills, problem solving skills, communication skills and emotional sensitivity. Therefore, based on the user's answers to the questions, the evaluator scores the user's performance and determines the user's competency in terms of various co-scholastic skills including attitude towards life, moral values, critical thinking skills, creative thinking skills, decision making skills, analytical skills, problem solving skills, communication skills and emotional sensitivity. The system 100 further includes a scoring module (not shown in figures) co-operating with the evaluator 18F to score the user's performance in answering the assessment questionnaire provided by the assessment processor 18. The scores provided to the user correspond to user's performance in co-scholastic skills including critical thinking skills, creative thinking skills, decision making skills, analytical skills, problem solving skills, communication skills and emotional sensitivity.

In accordance with the present disclosure, the first user interface 14 is configured to display to the user the information corresponding to the short speechless movies previously viewed by the user, and the assessment questionnaires previously answered by the user. The first user interface also displays the scores obtained by the user in all the assessment tests previously answered by the user. In accordance with the present disclosure, the first user interface 14 also displays information corresponding to the short speechless films to be presented/displayed to the user and the pattern of the corresponding assessment questionnaire to be answered by the user. The system further includes a report generating cooperating with the evaluator module 18F and configured to generate customized reports corresponding to user's performance in acquiring co scholastic skills including attitude towards life, moral values, critical thinking skills, creative thinking skills, decision making skills, analytical skills, problem solving skills, communication skills and emotional sensitivity. The reports can be generated individually for each skill or collectively for a set of skills. The reports preferably include graphs indicating the user's performance along with the corresponding scores/ratings obtained by the user.

In accordance with an embodiment of the present disclosure, the user is a student. The student is associated with a teacher monitoring his co-scholastic activities, and a school. In accordance with the embodiment of the present disclosure, the student, the teacher and the school authorities are enabled to access the system 100 through the first user interface 14. For the purpose of providing access to the system 100, a unique username and password are respectively assigned to the student, teacher and school authorities respectively.

In accordance with this embodiment, when a student logs on to the system 100 through the user interface 14, the user interface 14 displays two options to the student, namely ‘student history’ and ‘current assignments’. The ‘student history’ segment provides information about the short speechless films previously viewed by the student, the assessment tests previously answered by the student and the results (scores) of the previous assessment tests previously answered by the student. The ‘current assignments’ segment provides the information regarding the short speechless films to be viewed by the student, the pattern of the assessment tests to be answered by the student and the number of assessment tests to be answered by the student.

Further, the menu generator 14A generates a menu which comprises data fields corresponding to at least student's age, student's sensibility levels and student's cultural milieu. The menu generated by the first menu generator 14A is displayed to the student on the user interface 14. The menu generator 14A elicits information corresponding to student's age, sensibility levels and cultural milieu from the student. The information elicited by the menu generator 14A is stored in the first repository 10. The first repository 10 also stores a plurality of short speechless films. The short speechless films concentrate on a plurality of co-scholastic skills including attitude towards life, moral values, critical thinking skills, creative thinking skills, social skills, decision making skills, problem solving skills, effective communication skills, interpersonal relationship skills, emotional sensitivity and the like. The short speechless films stored in the first repository 10 are annotated and classified based on at least student's age, sensibility levels and cultural milieu (input by the student through the user interface 14), by the first annotator 12.

Based on the information input by the student corresponding to his age, sensibility levels and cultural milieu, the selection module 16 automatically selects a suitable short speechless movie to be displayed to the student. In accordance with this embodiment, the selection module 16 can also select a short speechless film that is relevant to the student's academic curriculum.

Subsequent to viewing the short speechless film, the student is required to answer an assessment test generated by the assessment processor 18. In accordance with this embodiment, the assessment processor 18 enables the student to select a language in which the assessment questions are to be displayed. The assessment test generated by the assessment processor 18 is related to the short speechless movie displayed/presented to the student.

In accordance with this embodiment, a plurality of sets of assessment questions are stored in the second repository 18A. The sets of assessment questions relate to co-scholastic skills including but not restricted to critical thinking skills, creative thinking skills, social skills, decision making skills, problem solving skills, effective communication skills, interpersonal relationship skills and emotional sensitivity. The assessment test evaluates the student for his competency in co scholastic skills including critical thinking skills, creative thinking skills, social skills, decision making skills, problem solving skills, effective communication skills, interpersonal relationship skills and emotional sensitivity. The sets of assessment questions have a one-to-one mapping with the short speechless movies stored in the first repository 10, i.e., each set of assessment questions correspond to a short speechless movie. The sets of assessment questions are annotated and classified based on at least the student's age, student's cultural milieu, the silent speechless movie that the assessment questions correspond to and student's sensibility levels, by the second annotator 18B. In accordance with this embodiment the sets of assessment questions can also be prepared by a teacher monitoring the co-scholastic activities of the student.

Based on the silent speechless movie screened to the student and based on the student's age, cultural milieu and sensibility levels, a set of assessment questions are extracted by the extractor 18C from the second repository 18A. A preparatory module prepares an assessment questionnaire comprising the assessment questions extracted by the extractor 18C. The assessment questionnaire is displayed to the student on a second user interface 18E. The second user interface enables the student to answer each of the assessment questions by selecting the appropriate option as the answer. The student can select the appropriate answer either by touch if the second user interface is being displayed on a touch screen or by a click if the second user interface is being displayed on a conventional display screen.

The answers provided to assessment questions are evaluated by an evaluator 18F for correctness. The evaluator cooperates with the second repository 18A which stores the correct answers to each of the sets of assessment questions, to evaluate the answers provided by the student. The assessment questions contained in the assessment questionnaire relate to various co-scholastic skills including but not restricted to critical thinking skills, creative thinking skills, decision making skills, analytical skills, problem solving skills, communication skills and emotional sensitivity. Therefore, based on the student's answers to the assessment questions, the evaluator 18F scores/rates the student's performance and determines the student's competency in terms of various co-scholastic skills including attitude towards life, moral values, critical thinking skills, creative thinking skills, decision making skills, analytical skills, problem solving skills, communication skills and emotional sensitivity.

In accordance with this embodiment of the present disclosure, a teacher is provided with the facility of accessing the system 100 and select, track the performance of a student. When a teacher logs on to the system 100, he is provided with a list of students accessing the system 100. Preferably, the list of student, is segregated based on the school that they are studying in. Preferably, the list of students is also segregated based on the class that they are studying in. When the teacher selects the name of a student(s), the student's scores/rating in terms of various co-scholastic skills including but not restricted to attitude towards life, moral values, critical thinking skills, creative thinking skills, decision making skills, analytical skills, problem solving skills, communication skills and emotional sensitivity are displayed to the teacher. The teacher can assess a student's competency in co-scholastic skills using his/her own criteria. The teacher can also comment upon student's performance in acquiring co-scholastic skills. The teacher can also view the reports (corresponding to the student's performance in acquiring co-scholastic skills) generated by the report generation module.

In accordance with this embodiment of the present disclosure school authorities can also track the progress of a student, a group of students in acquiring co-scholastic skills by using the system 100. Short speechless movies can be presented and assessment tests can be conducted using the system 100, for a single student or a group of students or a class of students and subsequently their performance can be analyzed using the assessment processor 18.

In accordance with another embodiment of the present disclosure, a student can, by himself/herself assess his/her co scholastic skills including critical thinking skills, creative thinking skills, decision making skills, analytical skills, problem solving skills, communication skills and emotional sensitivity by using the system 100.

In accordance with another embodiment of the present disclosure, the system 100 provides a user, typically a student, with the facility of evaluating himself/herself. In accordance with this embodiment of the present disclosure, the student, accesses the system 100 through the first user interface 14. Further, the information corresponding to at least student's age, student's sensibility levels and student's cultural milieu is elicited by the first menu generator 14A and the information elicited by the menu generator 14A is stored in the first repository 10. The first repository 10 also stores a plurality of short speechless films. In acculrdaane with this embodiment of the present disclosure, the short speechless films concentrate on a plurality of co-scholastic skills including life skills, attitude towards life, moral values and the like. The short speechless films stored in the first repository 10 are annotated and classified based on at least student's age, sensibility levels and cultural milieu (input by the student through the user interface 14), by the first annotator 12.

Based on the information input by the student corresponding to his age, sensibility levels and cultural milieu, the selection module 16 automatically selects a suitable short speechless movie to be displayed to the student. In accordance with this embodiment, the selection module 16 can also select a short speechless film that is relevant to the student's academic curriculum.

Subsequent to viewing the short speechless film, the student is required to answer an assessment test generated by the assessment processor 18. In accordance with this embodiment, the assessment processor 18 enables the student to select a language in which the assessment questions are to be displayed. The assessment test generated by the assessment processor 18 is related to the short speechless movie displayed/presented to the student.

In accordance with this embodiment, a plurality of sets of assessment questions are stored in the second repository 18A. The sets of assessment questions relate to co-scholastic skills including but not restricted to life skills, attitude towards life and moral values. The assessment test evaluates the student for his competency in co scholastic skills including life skills, attitude towards life and moral values. The sets of assessment questions have a one-to-one mapping with the short speechless movies stored in the first repository 10, i.e., each set of assessment questions correspond to a short speechless movie. The sets of assessment questions are annotated and classified based on at least the student's age, student's cultural milieu, the silent speechless movie that the assessment questions correspond to and student's sensibility levels, by the second annotator 18B. In accordance with this embodiment the sets of assessment questions can also be prepared by a teacher monitoring the co-scholastic activities of the student.

Based on the silent speechless movie screened to the student and based on the student's age, cultural milieu and sensibility levels, a set of assessment questions are extracted by the extractor 18C from the second repository 18A. A preparatory module prepares an assessment questionnaire comprising the assessment questions extracted by the extractor 18C. The assessment questionnaire is displayed to the student on a second user interface 18E. The second user interface enables the student to answer each of the assessment questions by selecting the appropriate option as the answer. The student can select the appropriate answer either by touch if the second user interface is being displayed on a touch screen or by a click if the second user interface is being displayed on a conventional display screen.

The answers provided to assessment questions are evaluated by an evaluator 18F for correctness. The evaluator cooperates with the second repository 18A which stores the correct answers to each of the sets of assessment questions, to evaluate the answers provided by the student. In accordance with this embodiment of the present disclosure, instead of a teacher, the student himself/herself is provided with access to the results provided by the evaluator 18F so that the student can assess his/her performance. The assessment questions contained in the assessment questionnaire relate to various co-scholastic skills including but not restricted to life skills, attitude towards life and moral values. The student, in accordance with this embodiment, is provided with access to the scores allotted to him/her based on his/her answers to the assessment questions. Further, the student is also enabled to view/self-review the scores/rates provided by the evaluator 18F corresponding to the student's life skills, attitude towards life and moral values.

In accordance with another embodiment of the present disclosure, a student using the system 100 can also assess various co-scholastic skills including but not restricted to life skills, attitude towards life and moral values, of his/her selected peers (typically a student can assess the co scholastic abilities/skills of his/her classmates). In accordance with this embodiment of the present disclosure, instead of a teacher, the student who is assessing the co-scholastic abilities of his/her peers is provided with access to the results provided by the evaluator 18F so that the student can assess his/her peer's performance. The assessment questions contained in the assessment questionnaire relate to various co-scholastic skills including but not restricted to life skills, attitude towards life and moral values. The student, in accordance with this embodiment, is provided with access to the scores allotted to his/her peers based on the peers' answers to the assessment questions. Further, the student who is assessing the co scholastic abilities of his/her peer is also enabled to view/self-review the scores/rates provided by the evaluator 18F corresponding to peers' life skills, attitude towards life and moral values.

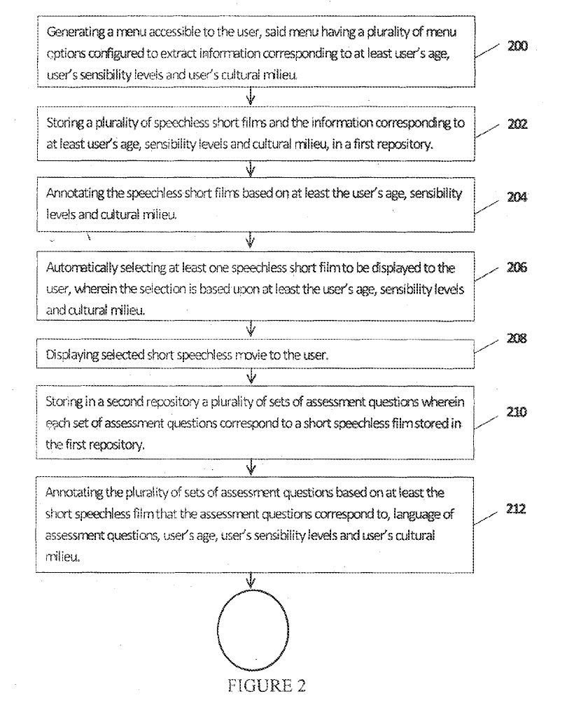

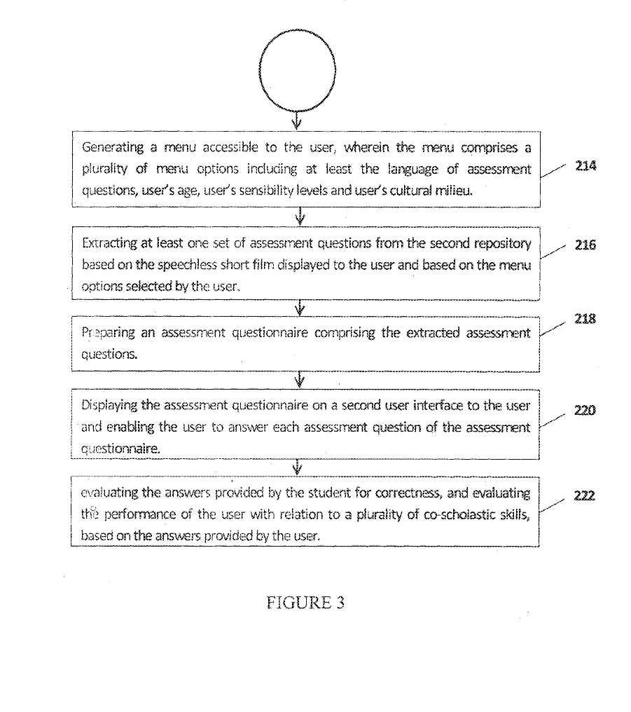

Referring to FIG. 2 and FIG. 3 there is shown a computer implemented method for statistically assessing co-scholastic skills of a user. The method, in accordance with the present disclosure includes the following computer implemented steps:
generating a menu accessible to the user, said menu having a plurality of menu options configured to extract information corresponding to at least user's age, user's sensibility levels and user's cultural milieu 200;
storing a plurality of speechless short films and the information corresponding to at least user's age, sensibility levels and cultural milieu, in a first repository 202;
annotating the speechless short films based on at least the user's age, sensibility levels and cultural milieu 204;
automatically selecting at least one speechless short film to be displayed to the user, wherein the selection is based upon at least the user's age, sensibility levels and cultural milieu 206;
displaying selected short speechless movie to the user 208;
storing in a second repository a plurality of sets of assessment questions wherein each set of assessment questions correspond to a short speechless film stored in the first repository 210;
annotating the plurality of sets of assessment questions based on at least the short speechless film that the assessment questions correspond to, language of assessment questions, user's age, user's sensibility levels and user's cultural milieu 212;
generating a menu accessible to the user, wherein the menu comprises a plurality of menu options including at least the language of assessment questions, user's age, user's sensibility levels and user's cultural milieu 214;
extracting at least one set of assessment questions from the second repository based on the speechless short film displayed to the user and based on the menu options selected by the user 216;
preparing an assessment questionnaire comprising the extracted assessment questions 218;
displaying the assessment questionnaire on a second user interface to the user and enabling the user to answer each assessment question of the assessment questionnaire 220; and
evaluating the answers provided by the student for correctness, and evaluating the performance of the user with relation to a plurality of co-scholastic skills, based on the answers provided by the user 222.

In accordance with the present disclosure, the step of displaying a speechless short film to the user further includes the following steps:
displaying information corresponding to the short speechless films previously viewed by the user;
displaying information corresponding to the assessment tests previously answered by the user;
displaying information corresponding to the short speechless films to be displayed to the user and the pattern of the corresponding assessment questionnaire.

In accordance with the present disclosure, the step of automatically selecting at least one speechless short film to be displayed to the user further includes the step of selecting at least one short film based on the academic curriculum prescribed to the user.

In accordance with the present disclosure, the step of storing in a second repository a plurality of sets of assessment questions further includes the step of storing multiple choice questions.

In accordance with the present disclosure, the method further includes the step of assigning scores to the user according to user's performance in the assessment test.

In accordance with the present disclosure, the method includes the step of generating statistical graphs and customized report(s) illustrating the performance of the user in the assessment test.

In accordance with the present disclosure, the step of evaluating the performance of the user with relation to a plurality of co-scholastic skills includes the step of evaluating the user based on at least attitude towards life, moral values, critical thinking skills, creative thinking skills, decision making skills, problem solving skills, effective communication skills, interpersonal relationship skills, emotional sensitivity and stress handling skills.

### Technical Advantages

The technical advantages of the present disclosure include the realization of following:
providing a system that provides for statistical measurements of users' competency and performance in co-scholastic areas;
providing a system that accurately accesses the user's strengths and weaknesses;
providing a system that provides quantifiable feedback to the user regarding his/her performance in co-scholastic activities;
providing a system that accurately tracks the overall performance of users in exhibiting co-scholastic skills;
providing a system that eliminates the requirement of manual feedback process;
providing a system that enables users to develop their personalities by providing them with a means for expressing themselves;
providing a system that helps for continuous monitoring and assessment of co scholastic skills of users;
providing a system that enables users to enhance their problem solving skills;
providing a system that enables users to become independent learners;
providing a system that automates the process of assessing users' competencies in co scholastic skills: and
providing a system that generates statistical reports denoting the level of co scholastic skills present in the user.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results.

Any discussion of documents, acts, materials, devices, articles or the like that has been included in this specification is solely for the purpose of providing a context for the invention. It is not to be taken as an admission that any or all of these matters form part of the prior art base or were common general knowledge in the field relevant to the invention as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the invention, unless there is a statement in the specification specific to the contrary.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A computer implemented system for statistically assessing co-scholastic skills of a user, said system comprising:
a menu generator configured to generate a menu accessible to said user, said menu having a plurality of menu options configured to extract information corresponding to at least user's age, user's sensibility levels and user's cultural milieu;
a first repository configured to store a plurality of speechless short films, said first repository further configured to store information corresponding to at least user's age, sensibility levels and cultural milieu;
a first annotator cooperating with said repository, said first annotator configured to annotate said speechless short films based on at least user's age, sensibility levels and cultural milieu;
a selection module configured to automatically select at least one speechless short film to be displayed to the user, based on at least said user's age, sensibility levels and cultural milieu;
a first user interface configured to display said speechless short film to the user;
an assessment processor configured to generate an assessment test for evaluating the scholastic skills of the user, wherein said assessment test includes at least one set of assessment questions based on the short speechless film displayed to the user, said assessment processor comprising:
a second repository configured to store a plurality of sets of assessment questions, wherein each set of assessment questions correspond to a short speechless film stored in said first repository;
a second annotator configured to annotate said plurality of sets of assessment questions based on at least the short speechless film that the assessment questions correspond to, language of assessment questions, user's age, user's sensibility levels and user's cultural milieu;
an extractor configured to extract at least one set of assessment questions from the second repository based on the speechless short film displayed to the user and based on the menu options selected by the user;
a preparatory, module configured to prepare an assessment questionnaire comprising the assessment questions extracted by said extractor;
a second user interface configured to display said assessment questionnaire to said user, said second user further configured to enable said user to answer each question of said assessment questionnaire; and
an evaluator configured to evaluate the answers provided by said student for correctness, said evaluator configured to evaluate the performance of the user with relation to a plurality of co-scholastic skills, based on the answers provided by the user.

2. The system as claimed in claim 1, wherein said first user interface is further configured to display information corresponding to the short speechless films previously viewed by the user and assessment tests previously answered by the user.

3. The system as claimed in claim 1, wherein said first user interface is configured to display information corresponding to the short speechless film(s) to be displayed to the user and the pattern of the corresponding assessment questionnaire.

4. The system as claimed in claim 1, wherein said selection module is further configured to select a short speechless movie based on academic curriculum prescribed to said user.

5. The system as claimed in claim 1, wherein the plurality of sets of assessment questions stored in the second repository include multiple choice assessment questions.

6. The system as claimed in claim 1, wherein said second repository is further configured to store the answers to the plurality of sets of assessment questions.

7. The system as claimed in claim 1, wherein said evaluator is further configured to generate statistical graphs indicating the performance of the user in said assessment test.

8. The system as claimed in claim 1, wherein said system further includes a scoring module configured to assign scores to the user according to the user's performance in said assessment test.

9. The system as claimed in claim 1, wherein said system further includes a report generation module configured to generate customized report(s) illustrating the performance of the user in said assessment test.

10. The system as claimed in claim 1, wherein said evaluator is configured to evaluate the performance of the user with relation to a plurality of co-scholastic skills including at least attitude towards life, moral values, critical thinking skills, creative thinking skills, decision making skills, problem solving skills, effective communication skills, interpersonal relationship skills, emotional sensitivity and stress handling skills.

11. A computer implemented method for statistically assessing co-scholastic skills of a user, said method comprising the following computer implemented steps:
generating a menu accessible to the user, said menu having a plurality of menu options configured to extract information corresponding to at least user's age, user's sensibility levels and user's cultural milieu;
storing a plurality of speechless short films and the information corresponding to at least user's age, sensibility levels and cultural milieu, in a first repository;
annotating said speechless short films based on at least said user's age, sensibility levels and cultural milieu;
automatically selecting at least one speechless short film to be displayed to the user, wherein the selection is based upon at least the user's age, sensibility levels and cultural milieu;
displaying selected short speechless movie to the user;
storing in a second repository a plurality of sets of assessment questions wherein each set of assessment questions correspond to a short speechless film stored in the first repository;
annotating said plurality of sets of assessment questions based on at least the short speechless film that the assessment questions correspond to, language of assessment questions, user's age, user's sensibility levels and user's cultural milieu;
extracting at least one set of assessment questions from the second repository based on the speechless short film displayed to the user and based on the menu options selected by the user;
preparing an assessment questionnaire comprising the extracted assessment questions;
displaying said assessment questionnaire on a second user interface to the user and enabling the user to answer each assessment question of said assessment questionnaire; and
evaluating the answers provided by said student for correctness, and evaluating the performance of the user with relation to a plurality of co-scholastic skills, based on the answers provided by the user.

12. The method as claimed in claim 11, wherein the step of displaying a speechless short film to the user further includes the following steps:
displaying information corresponding to the short speechless films previously viewed by the user;
displaying information corresponding to the assessment tests previously answered by the user;
displaying information corresponding to the short speechless films to be displayed to the user and the pattern of the corresponding assessment questionnaire.

13. The method as claimed in claim 11, wherein the step of automatically selecting at least one speechless short film to be displayed to the user further includes the step of selecting at least one short film based on the academic curriculum prescribed to the user.

14. The method as claimed in claim 11, wherein the step of storing in a second repository a plurality of sets of assessment questions further includes the step of storing multiple choice questions.

15. The method as claimed in claim 11, wherein the method further includes the step of assigning scores to the user according to user's performance in the assessment test.

16. The method as claimed in claim 11, wherein method includes the step of generating statistical graphs and customized report(s) illustrating the performance of the user in the assessment test.

17. The method as claimed in claim 11, wherein the step of evaluating the performance of the user with relation to a plurality of co-scholastic skills includes the step of evaluating the user based on at least attitude towards life, moral values, critical thinking skills, creative thinking skills, decision making skills, problem solving skills, effective communication skills, interpersonal relationship skills, emotional sensitivity and stress handling skills.
